(19) United States
(12) Patent Application Publication
(10) Pub. No.: US 2013/0122928 A1
(43) Pub. Date: May 16, 2013

(54) SYSTEMS AND METHODS FOR IDENTIFYING AND ACTING UPON STATES AND STATE CHANGES

(71) Applicant: Mark Oliver Pfluger, Oakland, CA (US)

(72) Inventor: Mark Oliver Pfluger, Oakland, CA (US)

(21) Appl. No.: 13/662,252

(22) Filed: Oct. 26, 2012

Related U.S. Application Data
(60) Provisional application No. 61/553,018, filed on Oct. 28, 2011.

(51) Int. Cl. G01P 13/00

(52) U.S. Cl. CPC G01P 13/00
USPC 455/456.1; 73/29.01; 73/488; 73/510; 73/700; 324/244; 374/100

(57) ABSTRACT

Systems and methods for determining states and state changes on a personal wireless device, and triggering actions upon these state changes. The personal wireless device includes at least a user interface, a positioning system and a system to determine the device acceleration. Examples of these systems are an accelerometer to determine the device acceleration and GPS (Global Positioning System) to determine the device position. States incurred from user movement include, but are not limited to: walking, driving, stationary. In one embodiment, the location of a parked vehicle is automatically saved, and a user interface to display past parking locations and guide the user to one of these parking locations, is offered.

### BACKGROUND OF THE INVENTION

In some instances drivers forget where they have parked their vehicles. This may be true when such drivers are in a hurry or in unfamiliar locations. In some circumstances, drivers may quickly pull into a parking spot without thinking about the parking location. In addition to being in a hurry, the size of a parking lot and the similarities of parking garages to one another contribute to forgetting the location of the parking spot and consequently a parked vehicle.

When a driver cannot remember where a vehicle of or associated with the driver was parked, there are limited options to assist in locating the vehicle. In some cases a driver may be able to acquire help from a security guard or a Good Samaritan to drive around a parking area and look for the lost vehicle. In other cases a driver may be able to use a remote control device to activate the horn or lights of the vehicle to assist in finding the parking location. Such options typically require the driver to be proximate to the vehicle for the remote to work, and may require considerable effort on part of the driver or one or more individuals assisting the driver.

U.S. Patent Publication No. 2009/0309759 has suggested a system and method to automate saving the parking location based on monitoring a user's speed with a GPS-capable device. U.S. Patent Publication No. 2010/0204877 provides a detection of the state of a vehicle and various actions to be performed based on the detected state. U.S. Patent Publication No. 2006/0111835 provides a system for locating a parked vehicle and a method for providing a location of a parked vehicle.

### SUMMARY OF THE INVENTION

In an aspect of the invention, a method for testing for a state change comprises receiving, from a first sensor, at least two signals indicative of a change of state of a user, the state selected from walking, driving and stationary. Next, if a state change is registered, verifying said change in state using a second sensor. In some instances, if a state change from driving to walking is registered, a geographic location (“geolocation”) of the user is received from a global positioning system, indicative of the location the user left a vehicle. The geolocation is then stored for future retrieval by a user.

In some embodiments, a method for testing for or calculating a state change of a user comprises receiving, from an accelerometer, a first signal at a first time point and a second signal at a second time point subsequent to the first time point. The first and second signals correspond to a state of a user, the state selected from walking, driving and stationary. Next, with the aid of a processor operatively coupled to the accelerometer, a change of state of the user is calculated. The change of state is calculated from the first signal and the second signal. Next, a geolocation of the user is received from a global position system or, alternatively, a system for estimating a geolocation of the user, such as a wireless triangulation system. The geolocation corresponds to a location of the change of state of the user calculated from the first signal and the second signals. The geolocation is recorded in an electronic storage medium.

In another aspect of the invention, a system for recording a geolocation of a user comprises a housing and an accelerometer in the housing, the accelerometer for (i) detecting a state of a user selected from walking, driving and stationary, and (ii) providing a signal (e.g., electronic signal) indicative of the state. A global positioning system is in the housing. The global positioning system is for detecting a geolocation of the user upon a change of state. A processor in the housing is operatively coupled to the accelerometer and the global positioning system. The processor (i) calculates a change of state of the user from a plurality of signals received from the accelerometer; (ii) determines a geolocation of the user upon a calculated change of state, wherein the geolocation is determined with the aid of geolocation data received from the global positioning system; and (iii) records the geolocation.

### INCORPORATION BY REFERENCE

All publications, patents, and patent applications mentioned in this specification are herein incorporated by reference to the same extent as if each individual publication, patent, or patent reference was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system and method for determining the state of a user, in accordance with an embodiment of the invention;

FIG. 2 shows a workflow of state transitions and decisions to automatically save the position of parking spots, in accordance with an embodiment of the invention;

FIGS. 3-7 show a graphical user interface (GUI) of a device configured to provide the position of saved parking spots, in accordance with an embodiment of the invention; and

FIG. 8 shows an accelerometer plot for a walking state;

FIG. 9 shows an accelerometer plot for a driving state; and

FIG. 10 shows a system for calculating a state change of a user, in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention.

The term “vehicle,” as used herein, refers to a device, machine or system configured to transport one or more users and/or cargo. In an example, a vehicle is an automobile, motor car, car, motorcycle, scooter, bicycle, bus, truck, train, boat, helicopter or airplane. When not in use, a vehicle may be stored in parking location (also “parking spot” herein).

The term “parking,” as used herein, is the act of stopping a vehicle and leaving it unoccupied for a brief period of time or more, such as 0.1 seconds or more, or 1 second or more, or 5 seconds or more, or 10 seconds or more, or 30 seconds or more, or 1 minute or more, or 10 minutes or more, or 30 minutes or more, or 1 hour or more, or 12 hours or more, or 1 day or more, or 1 week or more, or 1 month or more, or 1 year or more. Examples of parking spots include locations on or alongside roads or other driving structures, parking garages, and locations at businesses, such as parking facilities.

The term “user,” as used herein, is a person having.a personal wireless device equipped with the systems and methods discussed herein.

The term “state,” as used herein, refers to a user's state of motion, such as stopped (or stationary), walking or running or driving.

The term “state estimate,” as used herein, refers to a user's state as estimated from predictive data.

The term “average state,” as used herein, refers to the state derived from the state estimate as a function of previous state estimates.

The term “actual state,” as used herein, refers to a state derived with the aid of a state transition table, the average state and in some cases data from other sensors as input.

While there are systems and methods available in the art for enabling a user to find the user's vehicle in a parking location, recognized herein are various drawbacks and limitations associated with such methods. For example, state estimation based solely on speed may be incapable of differentiating walking from driving, such as differentiating rapid walking from slow driving, or being stopped in a car as opposed to stopping while walking. As another example, the constant use of a global positioning system.(GPS) to determine a user's speed may be prohibitive, due to the restricted battery power of personal wireless devices. As another example, state estimation based solely on data from an accelerometer or other motion sensors is not sufficient to determine state, as activities in different states render similar patterns in the data, e.g. fast driving and slow walking. Accordingly, recognized herein is a need in the art for improved systems and methods for enabling a user to find the user's vehicle.

Systems and methods described in embodiments of the invention enable a user to automatically determine the user's state and in some cases saving the user's location at predetermined way-points. Systems and methods provided herein are based at least in part on the notion that, in some cases, no single sensor can supply sufficient information to determine a user's state. Rather, a decision module uses information from various sensors to determine a user's state. This approach enables the best possible accuracy in estimating the state of a user while minimizing the consumption of stored energy, such as in a battery. In some cases, a user's state or location is monitored by employing a sensor with relatively higher power consumption less often.

In some embodiments, systems and methods determine whether a user is driving, walking (including running), or stationary, or whether a user is transitioning from a first state (e.g., driving or stationary) to a second state (e.g., stationary or walking). In an example, systems provided herein enable a user to determine whether the user is transitioning from a driving state to a walking or stationary state. In another example, systems provided herein determine whether a user is transitioning from a walking or stationary state to a driving state.

A personal wireless device suited as the basis for the presented systems and methods is a portable electronic device equipped with at least the following systems: a user interface, a positioning system and a system to determine the device acceleration, such as, e.g., an accelerometer. The device may carry other systems, many of them suitable to determine state, such as, e.g., motion sensors, like' a gyrometer or an accelerometer; sound recording devices; optical cameras; altimeters; ambient light sensors; temperature sensors; humidity sensors; magnetometer; spectroscopes; and/or other systems and sensors relaying physical information in a format accessible to data processing on the device.

Systems and methods provided herein may be implemented in hardware, on a device for that particular purpose only, or in software on a programmable multipurpose device. Examples of such devices include, but are not limited to: mobile phones, Smart phones (e.g., Apple® iPhone, Android® enabled phones), personal digital assistants (PDAs), slate or tablet computers (e.g., Apple® iPad®, Samsung® Galaxy Tab, BlackBerry® Playbook), laptops, and desktop personal computers (PCs).

States are a formal representation of the user's environment or actions. These include, but are not limited to: walking, jogging, running, driving, stationary, no interaction, screen interaction, talking on the phone. In some embodiments of the invention, a driving state can be associated with the type of vehicle, including, but not limited to: automobile, motor car, car, motorcycle, scooter, bicycle, bus, truck, train, boat, helicopter or airplane.

In an embodiment, a system acquires and saves the current position when a state change from driving to walking occurs. This location coincides with the parking spot of the vehicle, if the user was also the driver of the vehicle. In another embodiment, a system acquires and saves the current position when a state change from walking to driving occurs.

In some embodiments, a user's location is estimated with the aid of a geolocation system (e.g., global positioning system (GPS)) in an electronic device (e.g., Smart phone, tablet) of or associated with a user to obtain the user's location, and the user's state (e.g., driving, stationary, walking) is estimated with the aid of an inertial motion sensor (e.g., accelerometer) and the geolocation system (e.g., GPS) of the electronic device. As an alternative, a user's location is estimated with the aid of triangulation, such as, for example, wireless triangulation to a plurality of cell towers or wireless hot spots. In some embodiments, upon a user's state change (e.g., driving to stationary or driving to walking), the system records the user's location as a last-known location. In cases in which the user was driving and subsequently came to a stop, the last-known location may coincide with the location of the user's vehicle. When the user desires to retrieve the location of the user's vehicle, the electronic device will provide the last-known location to the user, such as with the aid of a map on a graphical user interface (GUI) of the electronic device. In some situations, by monitoring state change and monitoring a location of a user upon a state change (or request by a user) with the aid of a GPS module (or sub-system) on the electronic device, the utilization of resources may be minimized.

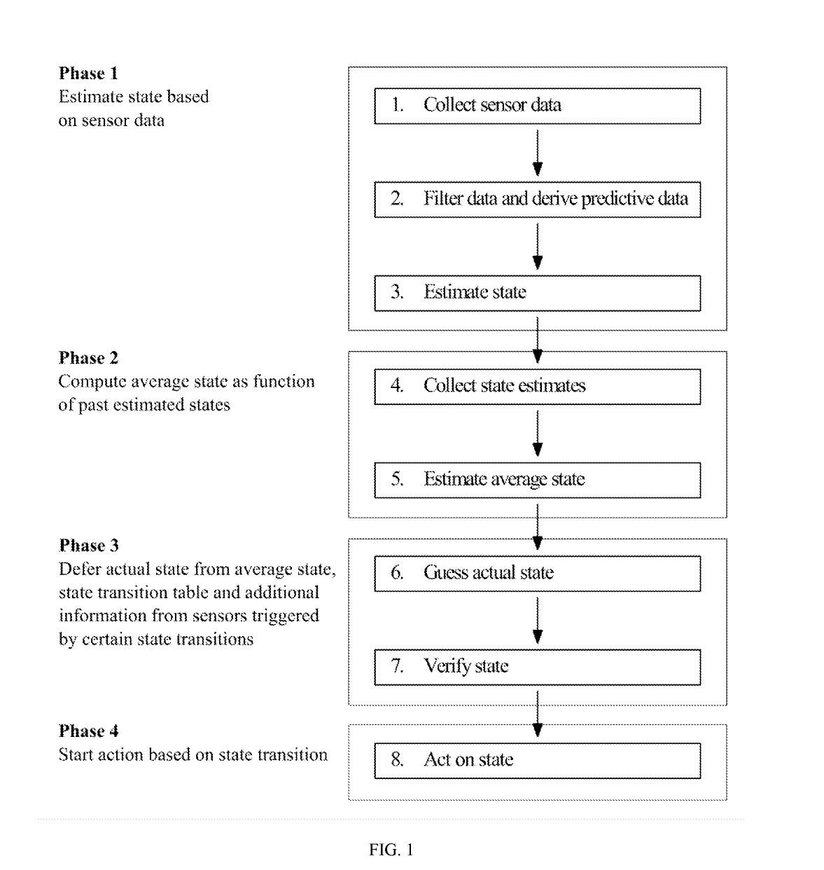

Referring to FIG. 1, illustrated is a block diagram of the general method to determine user state from one or more sensors comprised in a portable device on or associated with the user, in accordance with an embodiment of the invention. In some embodiments, the one or more sensors are selected from a global positional system (“GPS”) and an accelerometer. In some situations, other inertial motions sensors can be used in place of, or in conjunction with, an accelerometer. Data from the one or more sensor arrive at certain, predetermined intervals. In a first phase (Phase 1), the data received from a sensor or multiple sensors are collected over a certain period of time, or over a predetermined number of intervals. In some cases, data is received from one or more sensors over a period of time between about 0.01 seconds and 10 minutes, or 0.1 seconds and 1 minute. In other cases, data is received from one or more sensors over at least 1, or 2, or 3, or 4, or 5, or 10, or 20, or 100, or more intervals. The intervals may be separated by various lengths of time, such as at least 0.01 seconds, or 0.1 seconds, or 1 second, or 10 seconds, or 100 seconds, or 1000 seconds, or 10,000 seconds. This data may be filtered, to compensate for any imprecision of the sensor supplying the data and other effects, known to one skilled in the art. Filters that may be applied to the initial sensor data include, but are not limited to: delay filter, moving average filter, discrete filter, low-pass filter, high-pass filter, Chebyshev filter, or other filters. Such filters may also be employed after transforming the data.

In some situations, predictive data is derived from the filtered data by aggregating, processing and transforming said filtered data. Predictive data is used to recognize patterns that can be attributed to user states. This recognition may be based on given thresholds, adapting thresholds, or any method from the field of pattern recognition, including, but not limited to, naïve Bayes classifier, decision tree, support vector machines, neural networks, perceptrons, kernel estimation, clustering, hidden Markov models, and Bayesian networks.

Additional methods may be employed to combine sensor data from different sensors in Phase 1 to derive data with higher information content concerning the predictability of user state. Methods that may be used, include, but are not limited to Kalman filters.

Next, in a second phase (Phase 2), these state estimates are aggregated and the average state is derived from previous state estimates with a predetermined weight function. This smoothes the prediction values by eliminating or reducing the weight of outlying state estimates. In some embodiments of the invention, this phase may be omitted.

In a third phase (Phase 3), the average state is used to determine the current estimate of the actual user state (i.e., walking, driving, stationary). A transition table is used to only allow for possible transitions between actual user states. Additional sensors, which may be more taxing from a resource or processing standpoint, are used to back up the initial estimate for actual user state. As discussed above, this additional sensor data may be filtered, processed, aggregated and transformed. At this step other restrictions based on external knowledge may be applied, for example to disregard changes in speed or location that are highly improbable (due to restrictions of maximum speed in certain vehicles, absolute maximum speed, or other physical reasoning). This step may take varying amounts of time to determine the actual user state. Associated with the user state may be a probability, which reflects the level of confidence that the final estimate is correct.

Once the actual user state is determined with a predetermined level of confidence (which may be user defined), in a fourth phase (Phase 4), one or more actions are executed. According to different embodiments of the invention, different actions or action sets may be triggered. The predetermined level of confidence may be system-defined or selected by a user. In some cases, the predetermined level of confidence is at least about 40%, or 45%, or 50%, or 55%, or 60%, or 65%, or 70%, or 75%, or 80%, or 85%, or 90%, or 95%, or 99%, or 99.9%, or 99.99%, or 99.999%.

In an embodiment of the invention, the current position is saved on a transition from actual state driving to actual state not driving (e.g., walking or stationary). This position along with the time the save occurred, the distance to that position from the current position, the time the user drove in the vehicle before parking, and other information, can be presented to the user upon request, along with a map depicting the current location and the parking spot. Such information may be presented to the user with the aid of a user interface, such as graphical user interface (GUI) on a display of an electronic device on or associated with the user. Also a list of all saved parking spots can be displayed. Navigkion from the current location to the parking spot can be initialized and other typical actions taken. These actions include, but are not limited to, deleting saved parking spots, starting external navigation software, sending parking spots to other devices or users, and syncing parking spots with other devices or users.

The steps and/or phases described herein may be performed in the order presented, in another order, or combined. For instance, data collected from one or more sensors may be averaged and subsequently filtered, or averaged and filtered in a single step.

In other embodiments, systems and methods include, without limitation, the ability to store state-based access security for certain applications or features of portable devices (e.g.: disabling texting while driving, disabling other functions while driving); automating various actions on the portable device, such as, e.g., mobile device is set to car mode when in state driving, turning off WiFi while walking, turning off all radios during times of no interaction; user-tracking with minimal battery usage by minimizing GPS usage but still being able to determine important way points; tracking the traveled distance of a vehicle; recording live traffic information; recording points of interest visited by users, including but not limited to shops, malls, cafes, restaurants, gas stations and banks; and state-tracking (percentage of time spent in different states).

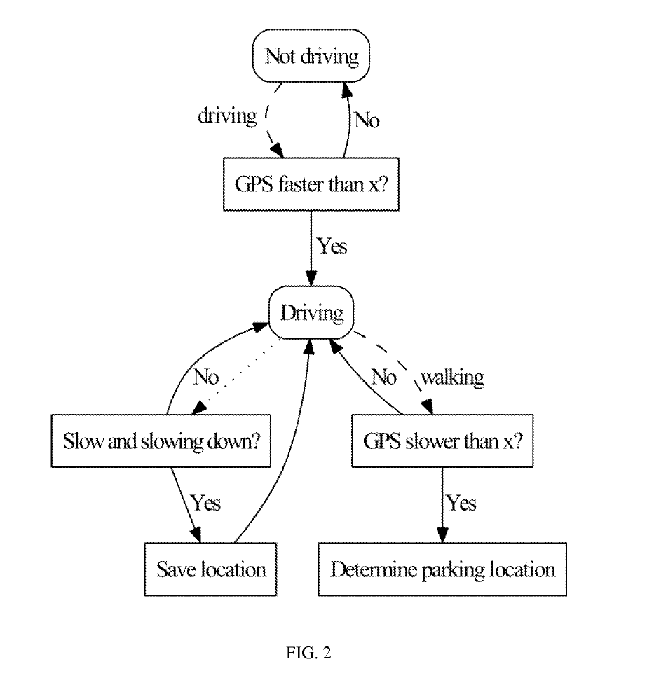

FIG. 2 illustrates a transition table, which may be used to save a geographic location (or geolocation) of a subject (or user) or a parking spot of the subject. In some embodiments, an accelerometer is used as the primary sensor to determine a user's state, thereby providing an initial estimate of the user's state, and sensors to determine a user's speed (or velocity) are used to verify the initial estimate. Sensors to defer speed include, but are not limited to: GPS or multilateration between wireless (e.g., WiFi, WIMAX) hotspots or radio towers (2G, 3G, 4G, long term evolution (LTE)). In other embodiments, other sensors may be used as primary or secondary sensors or multiple steps to verify the initial estimate with different sensors may be taken. Other possible primary or secondary sensors that may be used, include, but are not limited to, motion sensors, like a gyrometer, sound recording devices, optical cameras, altimeters, ambient light sensors, temperature sensors, humidity sensors, magnetometers, and spectroscopes.

Other sensors not included with the device may be accessible to the device with the aid of a communications interface (e.g., network interface or module), such as Bluetooth, WiFi, RFID or NFC or through an Internet connection. Examples of such sensors include a heart-rate monitor carried by the user, vehicle information provided by the vehicle, and home or office information provided by the user's home or office automation information system. In one embodiment this may be used to determine the proximity of the vehicle associated with the user. One example of this would be the presence of a Bluetooth connection with the user's vehicle.

A geolocation module of the device may be used to detect whether a user is stationary or moving, and whether the user's velocity (or speed) is increasing or decreasing, or remaining nearly constant that is, whether the user is accelerating, decelerating, or whether the user's velocity is constant (zero acceleration). This may be accomplished, for example, by recording the user's location (e.g., using wireless triangulation) at three consecutive points in time, a first time, second time and third time. If the user's location is the same at the three points in time, then the user is not moving. On the other hand, if the user's location at the second and/or third time points is different from the user's location at the first time point, then the user's velocity is non-zero and the user is thus not stationary. In addition, if the distance travelled by the user between the second and third time points is lower than the distance travelled by the user between the first and second time points, then the user's velocity is decreasing (or the user is decelerating). If the distance travelled by the user between the second and third time points is greater than the distance travelled by the user between the first and second time points, then the user's velocity is increasing (or the user is accelerating). If the distance travelled between the first and second time points and the second and third time points is the same and the user is not stationary, then the user's acceleration is zero. In other instances, the user's speed can be calculated with the aid of a global positioning system (GPS), which may use the Doppler effect to provide a speed estimate.

In an embodiment the accelerometer of the device is used to determine whether the user is driving, walking (or running), or stationary. In some cases, the accelerometer is configured to detect engine vibrations or motions that are characteristic of the driving state, and user motions that are characteristic of walking or running. In some situations, the device provideŝ the user the capability to program the device to match certain vibrations or motions to various accelerometer readings, such that the device can learn the user's behavior.

In some embodiments, sensor data received from the accelerometer is transformed into predictive data used for state estimation by a) separating gravity and acceleration from the initial accelerometer data with a low-pass filter; b) calculating the average total acceleration change, as the Euclidean distance to the last acceleration vector; c) calculating the maximum total acceleration change; d) calculating the average total gravity change, as the Euclidean distance to the last gravity vector; e) calculating the number of instances where the last and current acceleration value are similar in amplitude, but one has a positive and the other a negative value; f) calculating the number of instances where difference between the last local maximum and the last local minimum is higher than a given threshold g) calculating the number of instances where the difference between last and current acceleration values are bigger than a certain threshold, and one has a positive and the other a negative value; and h) calculating the maximum acceleration from all vectors.

With reference to FIG. 2, the actual user states assumed in the transition table (or process flow) are driving and not driving. Initially the user is not driving or operating a vehicle. Rounded boxes symbolize actual user state. The dashed arrows mark a transition initiated by a state change from the underlying average state estimation, and dotted arrows mark an action that runs in parallel and does not influence state. In some embodiments, average states and state changes are determined with the aid of an accelerometer. When the average state is driving, before the device sets the actual user state to driving, the GPS module is activated to determine the speed (or velocity) of the user. If at any point during a certain time period the user's speed is greater than a predetermined speed threshold, the actual user state is set to driving.

Referring again to FIG. 2, in some embodiments after state driving is determined with the aid of an accelerometer and before GPS is activated to determine the speed (or velocity) of the user, other sensors can be employed to back up the initial estimate for actual user state. In one embodiment this sensor is a magnetometer. Comparing the expected values of the earth's magnetic field at the user's current location to the actual magnetic field readings supplied by a magnetometer can detect disturbances in the earth's magnetic field, such as can be caused by a vehicle. This information may be used to assign a higher or lower probability value to state driving or defer the use of GPS until more data is acquired. The expected magnetic field at a given point on earth is generally estimated using the World Magnetic Model produced by the United States National Geospatial-Intelligence Agency.

To improve accuracy of the saved parking spot positions, the user's position is saved before the user leaves the user's vehicle. To achieve this, the user's speed is estimated, based, for example, on the frequency of shocks or other vibration pattern registered from the accelerometer, but other approaches for estimating the current speed can be employed. Accelerometer-detected shocks may be due to features on driving surfaces, such as roads. In some embodiments, if the distribution of irregularities is constant, the frequency of such irregularities can be used to estimate the speed at which the vehicle passes such irregularities. The speed can be used to determine whether the user is driving at or above one or more predetermined limits, which may be used to determine whether the user is driving “fast” or “slow.” In some cases, when the user's speed diminishes and is estimated as being slow, the current position is saved with the aid of the GPS module. This coincides, for the most part, with the vehicle stopping, for example, at a traffic light, traffic junction, or parking spot.

Once an average state of stationary or walking is registered, the GPS module is used again to record the user's location. In some situations, with the aid of the GPS module the device monitors, for a predetermined period of time, the user's speed. If the speed does not exceed a predetermined threshold, the final parking position is determined with the aid of the GPS module. Depending on the availability and accuracy of GPS at different times during the process of parking and leaving the car, the distance to the last saved location and the current location, and the time passed between location saves, the final parking position is selected from saved positions, acquired during the process of parking and leaving the car.

Sometimes, especially in parking structures, like underground parking garages, no positioning signal with sufficient accuracy can be acquired. In these cases, a facility to record user motion may be employed, until a position with sufficient accuracy can be acquired. This motion may be displayed on a map as a patch, to help guide the user from that position to the parking spot. Examples of sensors that may be used for motion tracking are an accelerometer to determine steps or speed while walking, and a magnetometer to determine direction. In another instance, the user may be prompted to manually enter parking spot information in the case where no positioning signal with sufficient accuracy can be acquired.

With continued reference to FIG. 2, a user's initial state is stationary or, alternatively, walking (“Not driving”). The device senses a potential state change from stationary or walking to driving. The electronic device then determines, with the aid of a GPS module of the device, whether the user's speed (or velocity) is greater than a predetermined limit (x) over a predetermined period of time. In some embodiments, the predetermined limit is at 5 miles per hour (mph), or 6 mph, or 7 mph, or 8 mph, or 9 mph, or 10 mph, or 11 mph, or 12 mph, or 13 mph, or 14 mph, or 15 mph, or 16 mph, or 17 mph, or 18 mph, or 19 mph, or 20 mph, or 21 mph, or 22 mph, or 23 mph, or 24 mph, or 25 mph. The predetermined limit in some cases is set (or programmed) by the user. The potential state change may be prompted by the accelerometer, such as when the device determines that the motion of the user, as measured by the accelerometer, is indicative of a driving state. If the velocity is not greater than the predetermined limit, the device determines that the user is not driving (“No”). However, if the velocity is greater than the predetermined limit, the device determines that the user is driving (“Yes”). The device then records in cache or memory (or other storage medium) the user's state and timestamp associated with that state. Next, if the estimated velocity of the user is below a certain threshold and decreasing, then the device saves the user's location with the aid of the GPS module of the device, but the device retains the user's state as driving. Once a state change to walking occurs, the GPS module is employed to gather the user's geolocation after leaving the car and monitor the user's speed. If the user's speed does not surpass a certain threshold for a predetermined amount of time, the final parking position is established from previously saved geolocations. The final parking position can be saved along with a timestamp (e.g., date; and/or time). In some situations, the device records this location as the user's parking location.

In some embodiments, an initial state change of a user can be estimated from one or more sensor signals. In some cases, a plurality of sensor signals can be aggregated to determine a state change. The initial state change can be verified with the aid of a geolocation system, which can include one or more sensor signals from geolocation modules (e.g., GPS). In some cases, a plurality of sensor signals from the geolocation system are aggregated to provide an estimate state of the user, which can be subsequently used to verify the initial state change.

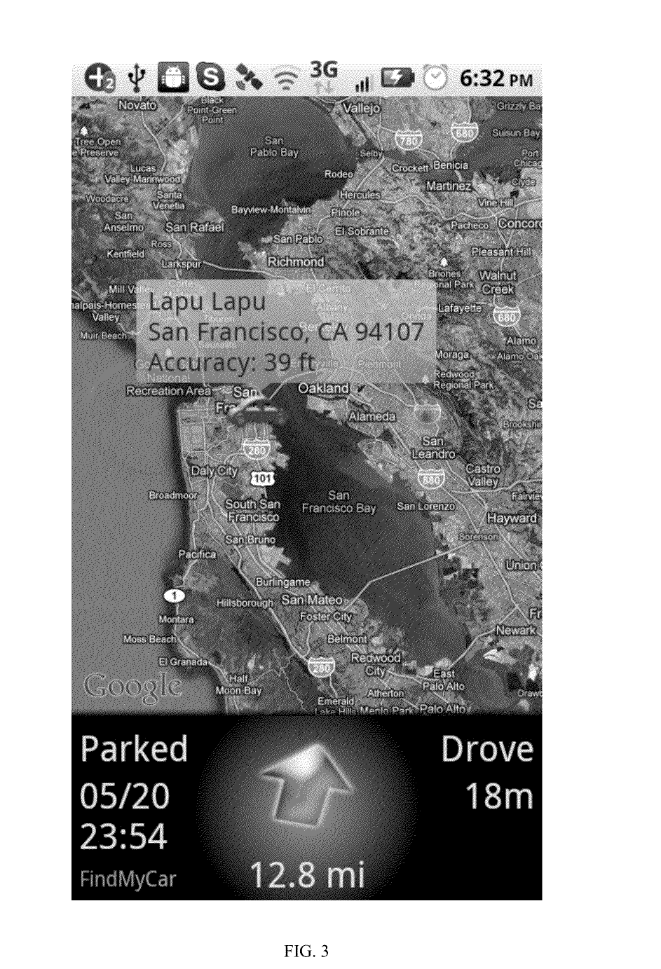

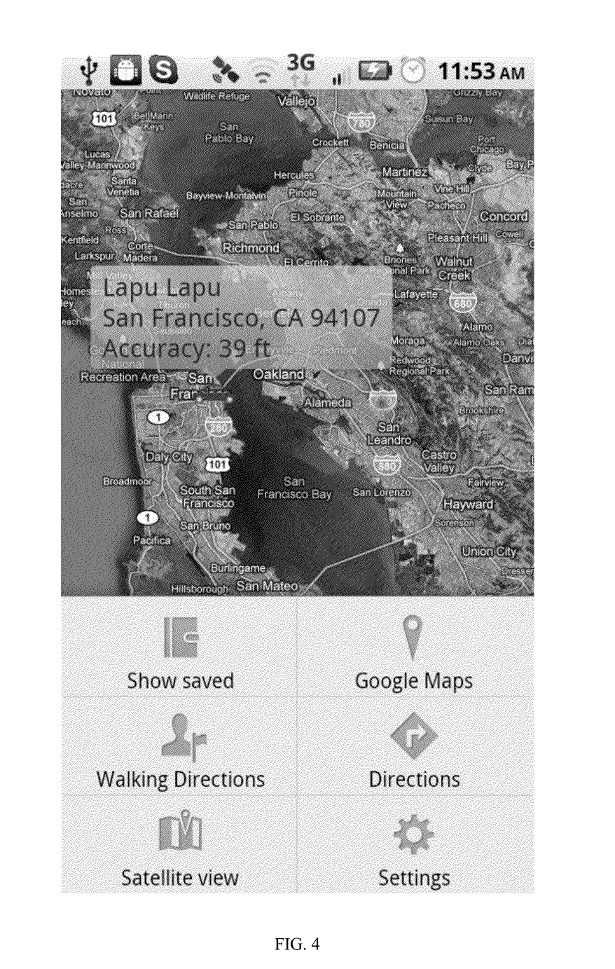

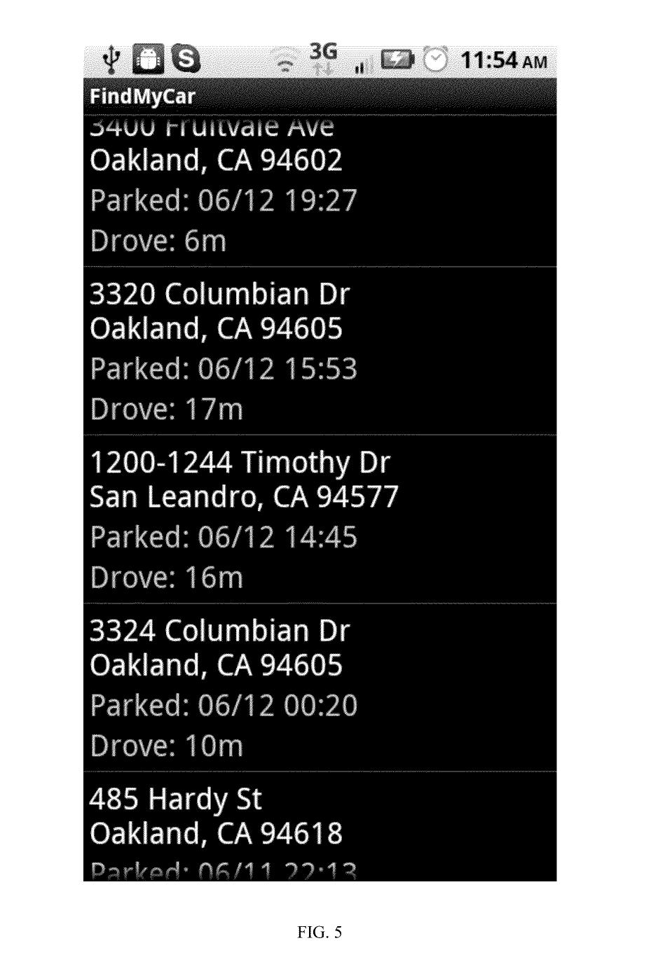

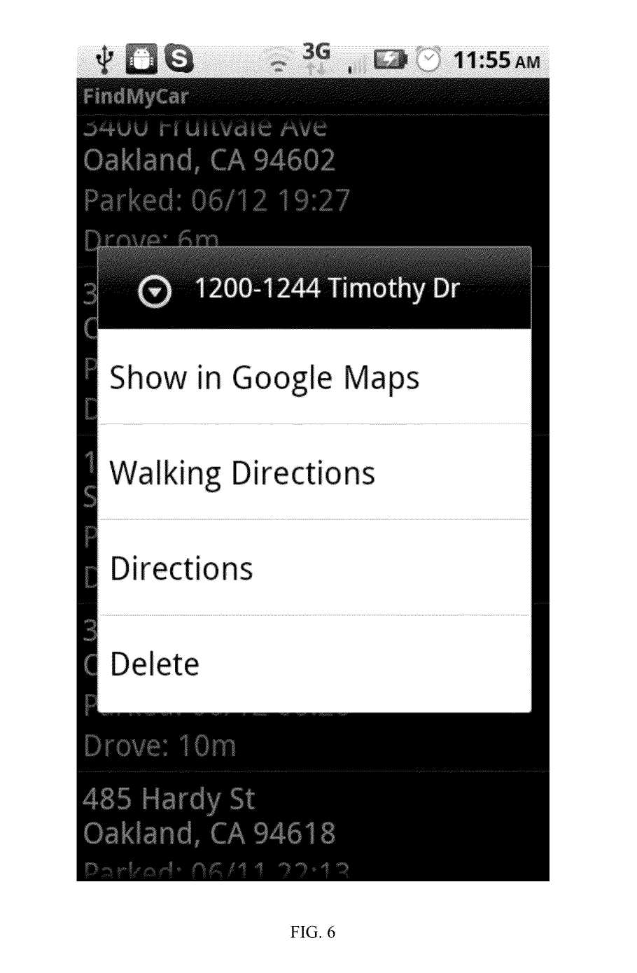

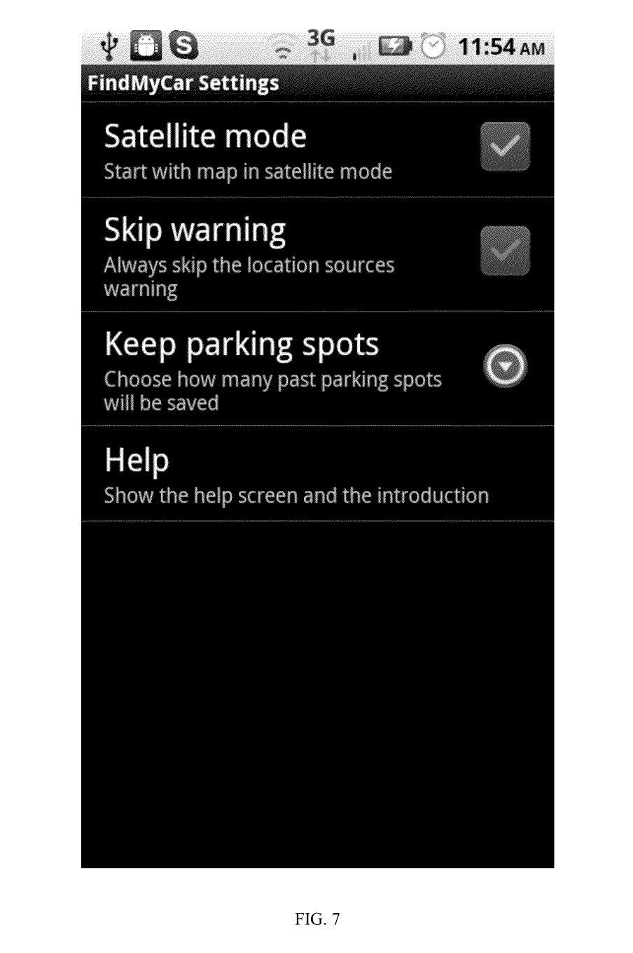

FIGS. 3-7 show a graphical user interface (GUI) of a device configured to provide the position of saved parking spots, in accordance with an embodiment of the invention. The GUI can be on an Android®-enabled phone or an iPhone®, to name a few examples.

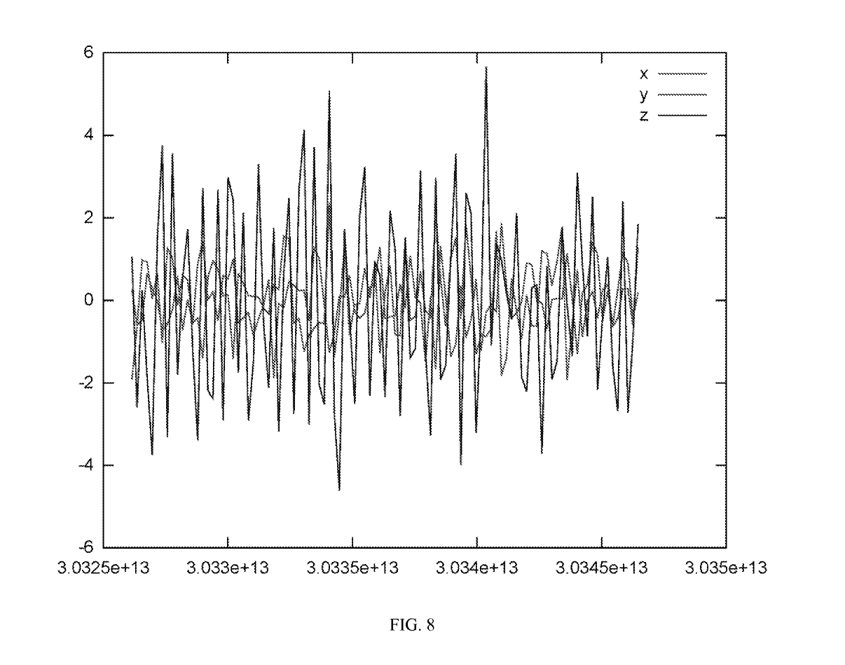

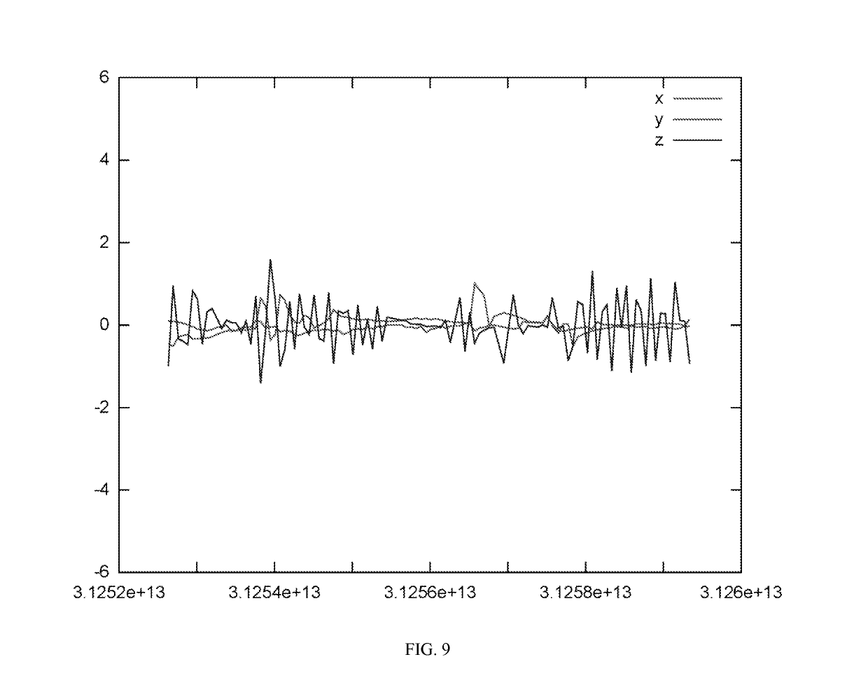

FIG. 8 shows an accelerometer plot for a user in a walking state. FIG. 9 shows an accelerometer plot for a user in a driving sate. The accelerometer data is filtered with a high pass filter to remove any effects or artifacts from gravitational acceleration (g force). The three input axes are plotted over time, the axes being the x, y and z axes. Systems and methods provided herein use plots such as those of FIGS. 8 and 9 to detect a change of state from walking to driving, and vice versa.

In some cases, when the system detects a change in state to the point in which the system declares that the change in state corresponds to a new state, at least about 1 second, or 2 seconds, or 3 seconds, or 4 seconds, or 5 seconds, or 10 seconds, or 20 seconds, or 30 seconds, or 1 minute, or 2 minutes, or 5 minutes, or 10 minutes elapses. In the meantime more state estimates accumulate to assure that the guess is correct and secondary systems, such as a global positioning system or the magnetometer or both, are used to verify the estimate.

In another aspect of the invention, devices and systems are provided for detecting a state change of the user and for enabling a user to find a user-defined (or user-selected) location of the user, such as a parked location of a vehicle of or associated with the user.

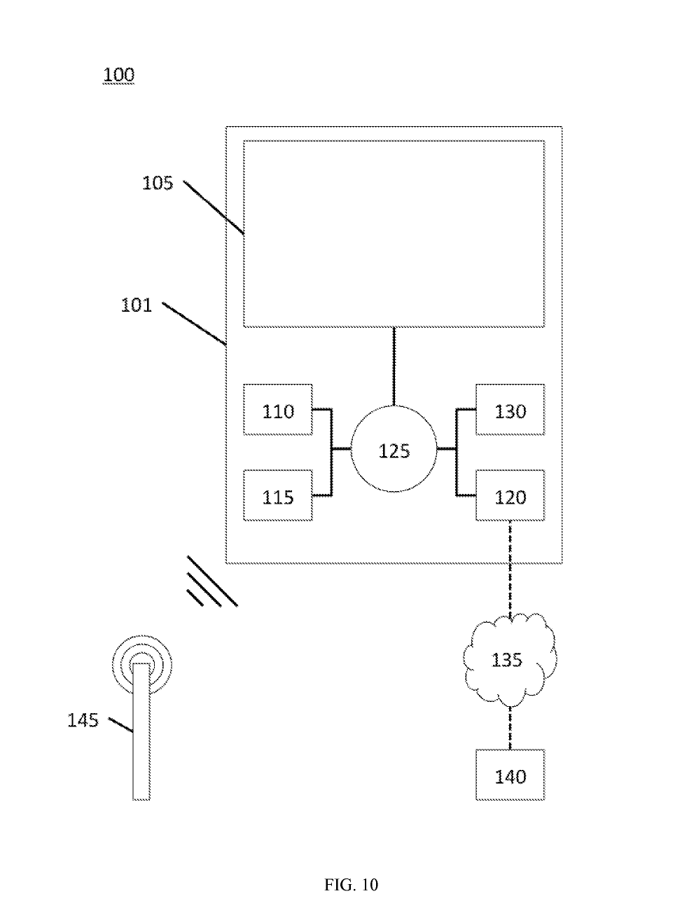

FIG. 10 shows a system for calculating a state change of a user, in accordance with an embodiment of the invention. The system 100 comprises an electronic device 101 having a housing, a display 105, a global positioning system (GPS) 110, an accelerometer 115, a communications interface 120, a processor 125 and a physical storage module 130. The physical storage module may include one or more of random-access memory (RAM), read-only memory (ROM), flash memory, cache, hard drive, in addition to one or more databases for storing information. The display 105, GPS 110, accelerometer 115, communications interface 120 and physical storage module 130 are operatively linked to the processor 125. The display 105 is configured to show a graphical user interface (GUI) to a user. The processor 125 may be a central processing unit (CPU). The device 100 is in communication with a network 135 with the aid of the communications interface 120. The network 130 may be an intranet and/or Internet. The network 135 is configured to bring the device 100 in communication with a system 140, which may be a remote computer (e.g., Smart phone, tablet, personal computer). The device 100 is configured to communicate with a wireless access point 145, such as a WiFi network, WIMAX network, 2G tower, 3G tower, 4G tower, long term evolution (LTE) tower, or other wireless transmitters and/or transponders. The wireless access point 145 may enable the device 100 to triangulate the location of a user having the device 100.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form,and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. A method for testing for a state change of a user, comprising:
(a) receiving, from a first sensor of an electronic device of said user, a plurality of signals;
(b) determining from said plurality of signals a change of mobility state of said user, said mobility state selected from walking, driving and stationary; and
(c) verifying said change in mobility state of said user using a second sensor of said electronic device.

2. The method of claim 1, wherein said first sensor is an inertial motion sensor.

3. The method of claim 2, wherein said inertial motion sensor is an accelerometer.

4. The method of claim 2, wherein said inertial motion sensor is a gyrometer.

5. The method of claim 1, wherein said first sensor is a geolocation system.

6. The method of claim 5, wherein said geolocation system is a global positioning system or a system based on triangulation of wireless senders, e.g. cell towers or Wi-Fi access points.

7. The method of claim 1, wherein said first sensor is a magnetometer or a humidity sensor or a illuminance sensor or an ambient pressure sensor or an ambient temperature sensor.

8. The method of claim 1, wherein said second sensor is a magnetometer or a humidity sensor or a illuminance sensor or an ambient pressure sensor or an ambient temperature sensor.

9. The method of claim 1, wherein said second sensor is a geolocation system.

10. The method of claim 9, wherein said geolocation system is a global positioning system or a system based on triangulation of wireless senders, e.g. cell towers or Wi-Fi access points.

11. The method of claim 1, wherein verifying said change in mobility state comprises measuring or estimating a speed of said user.

12. The method of claim 11, wherein said speed estimation is based on data from an inertial motion sensor.

13. The method of claim 12, wherein said inertial motion sensor is either an accelerometer or a gyrometer.

14. The method of claim 1, wherein step (a) comprises aggregating signals from multiple sensors.

15. The method of claim 1, wherein step (c) comprises aggregating signals from multiple sensors.

16. The method of claim 15, wherein said multiple sensors are a magnetometer and a geolocation system.

17. The method of claim 1, wherein upon verifying said change of mobility sate of said user, receiving, from a geolocation system of said electronic device, a geographic location of said user,

18. The method of claim 17, wherein said geographic location corresponds to a location of said change of state of said user.

19. The method of claim 18, further comprising recording said geographic location in a memory location of said electronic device.

20. The method of claim 1, wherein said electronic device is a portable electronic device.
